(19) United States
(12) Patent Application Publication
(10) Pub. No.: US 2004/0115380 A1
(43) Pub. Date: Jun. 17, 2004

(54) Footwear assembly made of polymeric and biodegradable compound material

(76) Inventors: Jung-Kuei Hsueh, Tainan (TW); Chen-Chih Yun, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/319,476

(22) Filed: Dec. 16, 2002

(51) Int. Cl. B32B 1/02

(52) U.S. Cl. 428/35.7

(57) ABSTRACT

A footwear assembly is composed of an out sole, an upper, and an insert, wherein the upper and the insert are positioned over the out sole. The upper is formed of a vamp, a toe box, a counter, a tongue, a quarter, and so on. One of the out sole, the upper, the insert, the vamp, the toe box, the counter, the tongue, and the quarter is made of the polymeric and biodegradable compound material.

### BACKGROUND OF THE INVENTION

1. Field of the Invention

The present invention relates generally to footwear, and more particularly to a footwear assembly made of a polymeric and biodegradable compound material.

2. Description of the Related Art

According to statistics, people on earth expend approximately ten billion pairs of shoes in one year and the shoes are accordingly one of human necessities. As the population of the people grows, the demand of the shoes will keep increasingly growing. In other words, the pollution resulted from deserted shoes are enormous and keep increasing. The shoes currently on the market are mostly made of plastic materials, such as polypropylene (PP), polyurethane (PU), ethylene vinyl acetate (EVA), artificial fibers, leatherette, etc., which are produced from petroleum and are harmful to the ecology and the environment of the earth while they are deserted. Although experts make efforts to recycle the above environment-unfriendly materials, it's inefficient to do so. Moreover, even if the materials are recyclable, the recycled materials are also provided for making merchandise, which is also environment-unfriendly, and the problem of the pollution is still not worked out.

### SUMMARY OF THE INVENTION

The primary objective of the present invention is to provide a footwear assembly made of a polymeric and biodegradable compound material. The footwear assembly is biodegradable and environment-friendly so as to be naturally decomposed and recycled by burying or composting after being deserted. Accordingly, environmental hazardous impacts will be dramatically reduced and the whole environment on earth will be further effectively protected.

The foregoing objective of the present invention is attained by the footwear assembly made of the polymeric and biodegradable compound material. The footwear assembly is composed of a out sole, an upper, and an midsole, wherein the upper and the midsole are positioned over the out sole. The upper is formed of a vamp, a toe box, a counter, a tongue, a quarter, and so on. One portion of the footwear assembly is made of the polymeric and biodegradable compound material.

### BRIEF DESCRIPTION OF THE DRAWINGS

FIG. 1 is a perspective view of a footwear assembly of a general shoe in accordance with the present invention;

FIG. 2 is a perspective view of a footwear assembly of a sports shoe in accordance with the present invention.

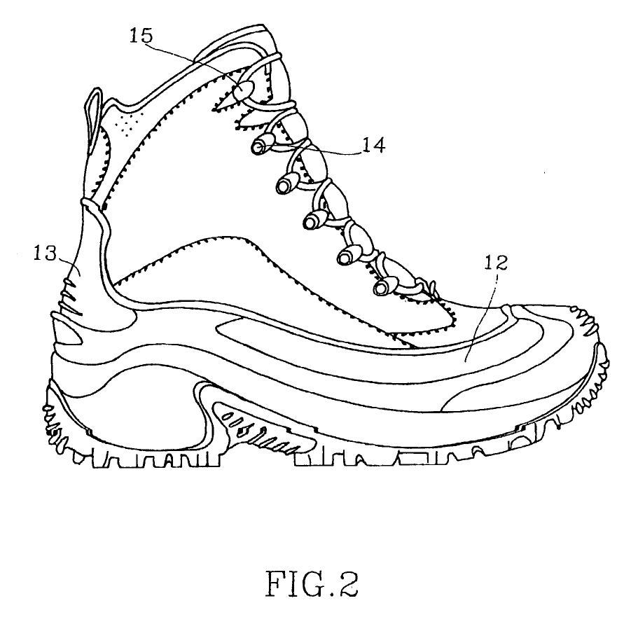

### DETAILED DESCRIPTION OF THE INVENTION

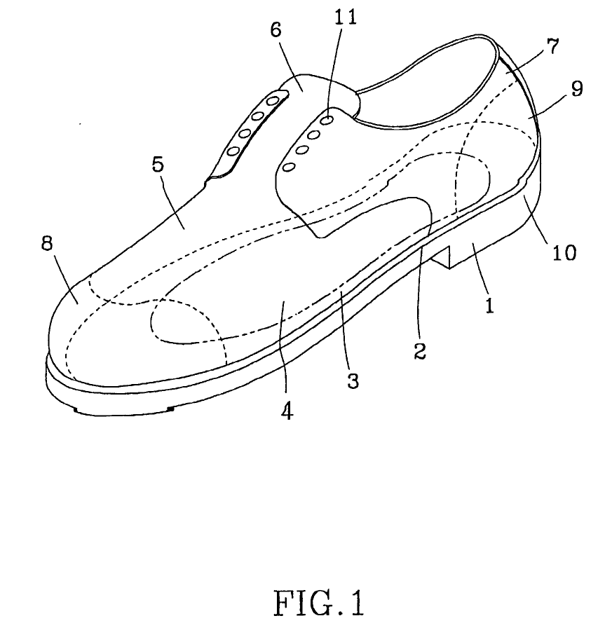

Since there are many kinds of shoes, such as leather shoes, high-heeled shoes, boots, roller skates, etc., footwear assemblies of the shoes differ from one another. Nevertheless, the footwear assembly is basically composed of an out sole 1, midsole 2 and an upper, which is positioned over the out sole 1. The footwear assemblies of some kinds of shoes are further composed of a footbed 3 and a filer 4. The upper has many different portions according to different kinds of shoes, and additionally, a polymeric and biodegradable compound material provided by the present invention can be applied to many kinds of shoes. Referring to FIG. 1, the upper is formed of a vamp 5, a tongue 6, a quarter 7, a toe box 8, a counter 9, and a welt 10, etc. The vamp 5 is disposed with a plurality of eyelet 11 thereon. The footwear assembly is made of the polymeric and biodegradable compound material, which is formed of grain or amylum or the like, at least one portion thereof as the following preferred embodiments of the present invention.

The out sole 1 and the midsole 2 of the footwear assembly of a first preferred embodiment of the present invention are made of hot-pressing or foaming or injection molding of a compound material of ethylene vinyl acetate (EVA) mixed with a biodegradable material. The proportion of EVA to the compound material ranges from 10% to 90%. Alternatively, the out sole 1 and the midsole 2 are made of the injection molding or plate extrusion of a compound material of thermoplastic urethane (TPU) mixed with the biodegradable material. The proportion of TPU to the compound material ranges from 10% to 90%. Alternatively, the out sole 1 and the midsole 2 are made of the injection molding of a compound material of thermoplastic polyurethane rubber (TPR) mixed with the biodegradable material. The proportion of TPU to the compound material ranges from 10% to 90%.

The toe box 8 and the counter 9 of the footwear assembly of a second preferred embodiment of the present invention are made of the injection molding of a compound material of polypropylene (PP) mixed with the biodegradable material. The proportion of PP to the compound material ranges from 10% to 90%. Alternatively, The toe box 8 and the counter 9 are made of the injection molding or plate extrusion of the compound material of TPU mixed with the biodegradable material. The proportion of TPU to the compound material ranges from 10% to 90%. Alternatively, The toe box 8 and the counter 9 are made of the injection molding of the compound material of TPR mixed with the biodegradable material. The proportion of TPR to the compound material ranges from 10% to 90%.

The footbed 3 and the filer 4 of the footwear assembly of a third preferred embodiment of the present invention are made of the foaming or cold-pressing of the compound material of EVA mixed with the biodegradable material. The proportion of EVA to the compound material ranges from 10% to 90%. Alternatively, The footbed 3 and the filer 4 are made of the foaming of a compound material of polyethylene (PE) mixed with the biodegradable material. The proportion of PE to the compound material ranges from 10% to 90%.

Referring to FIG. 4, the footwear assembly of a fourth preferred embodiment of the present invention includes a shell 12. The shell 12 is made of the injection molding of the compound material of TPU mixed with the biodegradable material. The proportion of TPU to the compound material ranges from 10% to 90%. Alternatively, the shell 12 is made of the injection molding of the compound material of PP mixed with the biodegradable material. The proportion of PP to the compound material ranges from 10% to 90%.

The over lay 13 of the footwear assembly of a fifth preferred embodiment of the present invention is made of the injection molding of the compound material of PP and the biodegradable material. The proportion of PP to the compound material ranges from 10% to 90%. Alternatively, the over lay 13 is made of the injection molding of the compound material of TPU mixed with the biodegradable material. The proportion of TPU to the compound material ranges from 10% to 90%.

Referring to FIG. 3, the footwear assembly of a sixth preferred embodiment of the present invention is composed of the eyelet 11 ,the hard wear 14 and hook 15, which are made of the injection molding of the compound material of PP mixed with the biodegradable material. The proportion of PP to the compound material ranges from 10% to 90%. Alternatively, the eyelet 11, the hard wear 14 and the hook 15 are made of the injection molding of the compound material of TPU mixed with the biodegradable material. The proportion of TPU to the compound material ranges from 10% to 90%. Alternatively, the eyelet 11, the hard wear 14 and the hook 15 are made of the injection molding of the compound material of polycarbonate (PC) mixed with the biodegradable material. The proportion of PC to the compound material ranges from 10% to 90%. Alternatively, the eyelets 11, the hard wear 14 and the hook 15 are made of the injection molding of the compound material of nylon mixed with the biodegradable material. The proportion of nylon to the compound material ranges from 10% to 90%.

The footwear assembly of the present invention made of the polymeric and biodegradable compound material includes advantages as follows:

1. Without altering the original manufacturing processes, functions, and components of the footwear assembly, the present invention makes environment-unfriendly materials, of which conventional footwear assembly is made, from the exclusive component to the additive component such that the environment-unfriendly materials will be dramatically abandoned and then the pollution and the hazardous impacts on the ecology and the environment will be highly dropped down.

2. The footwear assembly of the present invention can be naturally decomposed and recycled by burying and composting so as to be environment-friendly and effectively reduce the environmental pollution.

What is claimed is:

1. A footwear assembly made of a polymeric and biodegradable compound material, said footwear assembly comprising:
an out sole;
a midsole; and
an upper positioned over said out sole and having a vamp, a toe box, a counter, a footbed, a tongue, and a quarter;
one of said sole, said insert, said upper, said vamp, said toe box, said counter, said tongue, and said quarter being made of the polymeric and biodegradable compound material.

2. The footwear assembly as defined in claim 1, wherein said out sole and said midsole are made of a compound material of a biodegradable material mixed with ethylene vinyl acetate (EVA) or thermoplastic urethane (TPU) or thermoplastic polyurethane rubber (TPR), and the proportion of the biodegradable material to the compound material ranges from 90% to 10%.

3. The footwear assembly as defined in claim 1, wherein said toe box and said counter are made of a compound material of a biodegradable material mixed with polypropylene (PP) or thermoplastic urethane (TPU) or thermoplastic polyurethane rubber (TPR), and the proportion of the biodegradable material to the compound material ranges from 90% to 10%.

4. The footwear assembly as defined in claim 1 further including an footbed, wherein said insole is made of a compound material of a biodegradable material mixed with ethylene vinyl acetate (EVA) or polyethylene (PE), and the proportion of the biodegradable material to the compound material ranges from 90% to 10%.

5. The footwear assembly as defined in claim 1 further including a filer, wherein said filer is made of a compound material of a biodegradable material mixed with ethylene vinyl acetate (EVA) or polyethylene (PE), and the proportion of the biodegradable material to the compound material ranges from 90% to 10%.

6. The footwear assembly as defined in claim 1 further including a plurality of eyelets, wherein said eyelets are made of a compound material of a biodegradable material mixed with thermoplastic urethane (TPU) or polypropylene (PP) or nylon, and the proportion of the biodegradable material to the compound material ranges from 90% to 10%.

7. The footwear assembly as defined in claim 1 further including a plurality of hooks and hard wears, wherein said hooks and hard wears are made of a compound material of a biodegradable material mixed with thermoplastic urethane (TPU) or polypropylene (PP) or nylon, and the proportion of the biodegradable material to the compound material ranges from 90% to 10%.

8. The footwear assembly as defined in claim 1 further including a shell, wherein said shell is made of a compound material of a biodegradable material mixed with thermoplastic urethane (TPU) or polypropylene (PP), and the proportion of the biodegradable material to the compound material ranges from 90% to 10%

9. The footwear assembly as defined in claim 1 further including an over lay, wherein said over lay is made of a compound material of a biodegradable material mixed with thermoplastic urethane (TPU) or polypropylene (PP), and the proportion of the biodegradable material to the compound material ranges from 90% to 10%.
